(19) United States
(12) Patent Application Publication
(10) Pub. No.: US 2020/0379640 A1
(43) Pub. Date: Dec. 3, 2020

(54) USER-REALISTIC PATH SYNTHESIS VIA MULTI-TASK GENERATIVE ADVERSARIAL NETWORKS FOR CONTINUOUS PATH KEYBOARD INPUT

(71) Applicant: Apple Inc., Cupertino, CA (US)

(72) Inventors: Jerome R. BELLEGARDA, Saratoga, CA (US); Jui-Yang HSU, Kaohsiung City (TW); Partha LAL, Mountain View, CA (US); Akash MEHRA, San Mateo, CA (US)

(21) Appl. No.: 16/576,113

(22) Filed: Sep. 19, 2019

Related U.S. Application Data
(60) Provisional application No. 62/854,032, filed on May 29, 2019.

(51) Int. Cl. G06F 3/0488; G06N 20/20; G06F 17/27; G06F 17/18

(52) U.S. Cl. CPC G06F 3/04886; G06F 17/18; G06F 17/2765; G06N 20/20

(57) ABSTRACT

An example method includes at an electronic device with one or more processors and memory: obtaining first data representing a user-generated keyboard path for one or more words; obtaining second data representing a synthetic keyboard path for the one or more words; generating, using a first instance of a generative network, based on the first data and the second data, third data representing a modification of the synthetic keyboard path; determining whether the third data represent a second user-generated keyboard path; determining whether the third data represent the one or more words; and in accordance with a determination that the third data represent a second user-generated keyboard path and a determination that the third data represent the one or more words: training a model for keyboard path recognition based on the third data.

### CROSS REFERENCE TO RELATED APPLICATIONS

This application claims priority to U.S. Patent Application No. 62/854,032, entitled USER-REALISTIC PATH SYNTHESIS VIA MULTI-TASK GENERATIVE ADVERSARIAL NETWORKS FOR CONTINUOUS PATH KEYBOARD INPUT, filed on May 29, 2019, the content of which is hereby incorporated by reference in its entirety.

### FIELD

The present disclosure relates generally to keyboard path recognition.

### BACKGROUND

Keyboard path inputs can be used for text entry on electronic devices. For example, to enter text, a user may move a finger (or another apparatus) across a displayed keyboard with one or more continuous motions to generate a keyboard path. A path recognition model may then convert the keyboard path into text (e.g., keyboard characters). Because the accuracy and efficiency of keyboard path recognition can depend on the path recognition model used, improved techniques and models for keyboard path recognition are desirable.

### BRIEF SUMMARY

An example process for recognizing and generating keyboard paths includes at an electronic device with one or more processors and memory: obtaining first data representing a user-generated keyboard path for one or more words; obtaining second data representing a synthetic keyboard path for the one or more words; generating, using a first instance of a generative network, based on the first data and the second data, third data representing a modification of the synthetic keyboard path; determining whether the third data represent a second user-generated keyboard path; determining whether the third data represent the one or more words; and in accordance with a determination that the third data represent a second user-generated keyboard path and a determination that the third data represent the one or more words: training a model for keyboard path recognition based on the third data.

Training a model for keyboard path recognition based on the third data in accordance with a determination that the third data represent a second user-generated keyboard path and a determination that the third data represent the one or more words may allow training of more accurate and efficient keyboard path recognition models. In particular, determining that the third data represent a user-generated keyboard path prior to training a path recognition model based on the third data allows the model to be trained based on user-realistic keyboard paths. This may improve the model's ability to recognize user inputted paths. Further, determining that the third data represent the one or more words prior to training the model may improve the model's ability to distinguish between words, e.g., especially between words whose respective keyboard paths are close to each other, such as “GOAT” and “HOST.” Further, because the third data is determined based on a synthetic keyboard path (which may be relatively easy and inexpensive to generate), a large amount of training data can be generated for a path recognition model, which may improve the accuracy of the model. In this manner, the user-device interface is made more efficient (e.g., by quickly and accurately recognizing keyboard path inputs, by reducing repeated keyboard path inputs due to incorrect recognition, by increasing the efficiency of text entry), which additionally reduces power usage and improves battery life of the device by enabling the user to use the device more quickly and efficiently.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 6A illustrates a user-generated keyboard path, according to some embodiments.

FIG. 6B illustrates a synthetic keyboard path, according to some embodiments.

FIG. 6C illustrates a modified synthetic keyboard path, according to some embodiments.

FIG. 7 illustrates a system for keyboard path generation, according to some embodiments.

FIGS. 8A and 8B illustrate a system for keyboard path generation and recognition, according to some embodiments.

FIG. 8C illustrates an attention unit of FIGS. 8A and 8B, according to some embodiments.

FIG. 9 illustrates a system for generating and recognizing keyboard paths and for training models for keyboard path recognition, according to some embodiments.

FIGS. 10A-C illustrate a flow diagram of a process for generating and recognizing keyboard paths, according to some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

This relates generally to generating keyboard paths and training models for keyboard path recognition based on the generated paths. The systems and techniques discussed herein may provide various advantages over prior systems and techniques, such as more accurate path recognition models, improved user privacy, and improved techniques for training path recognition models.

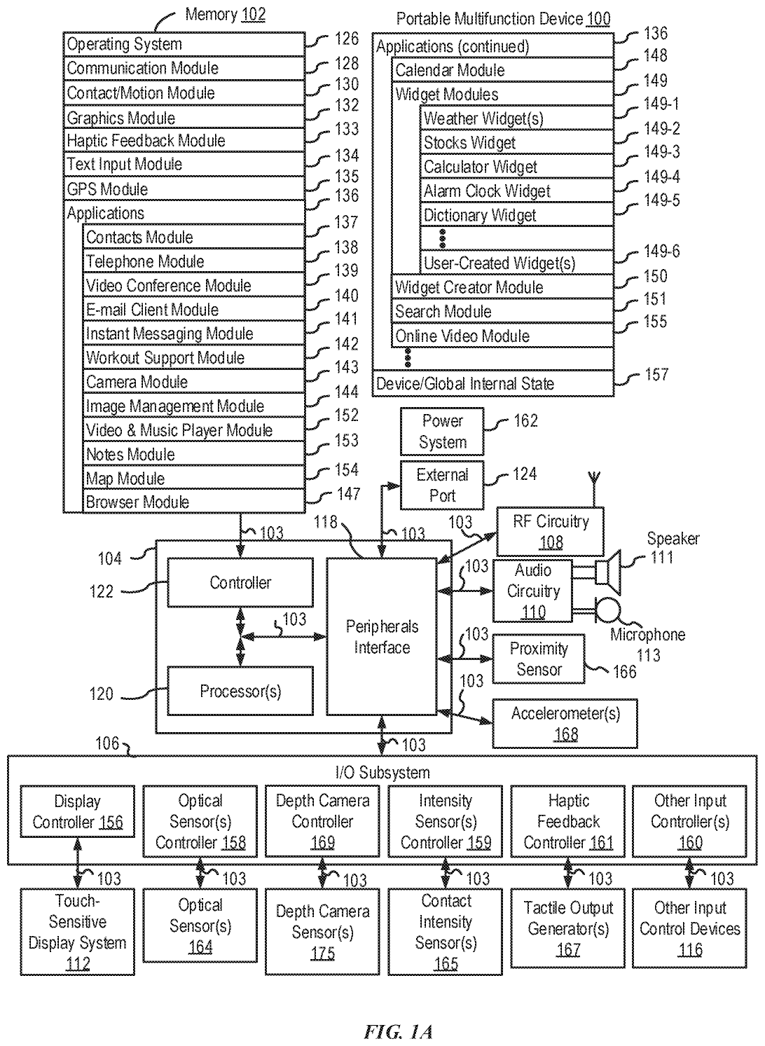

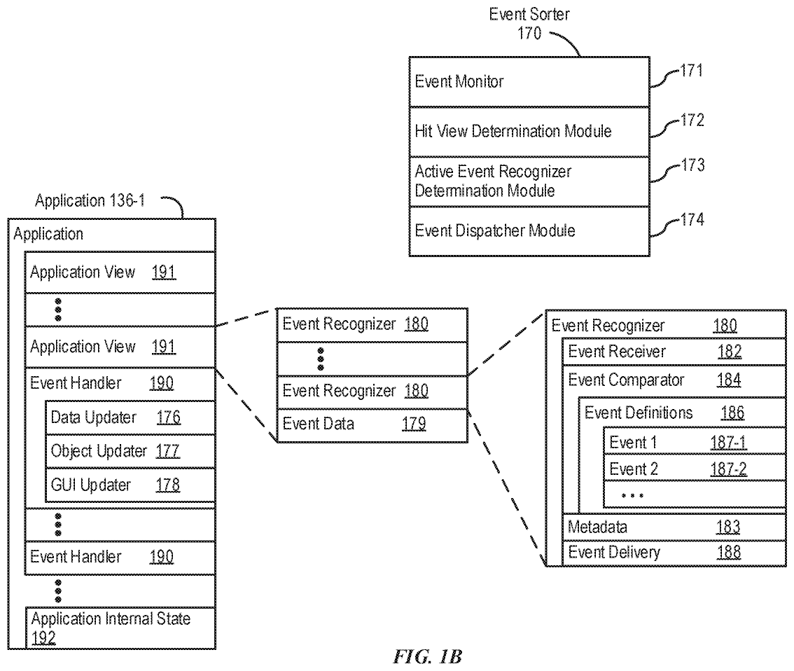

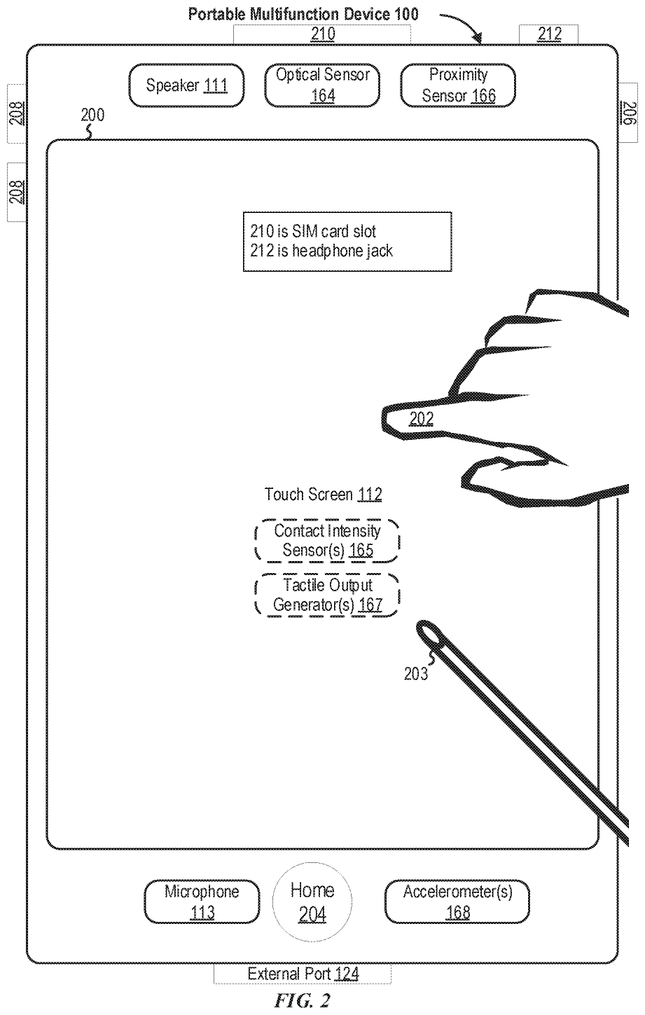

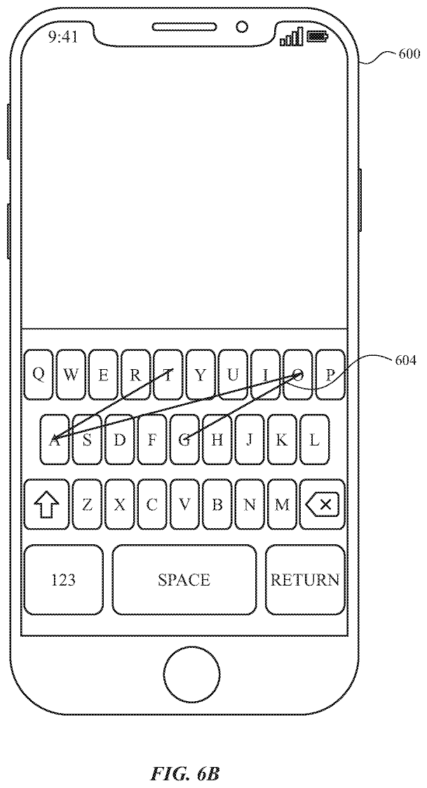

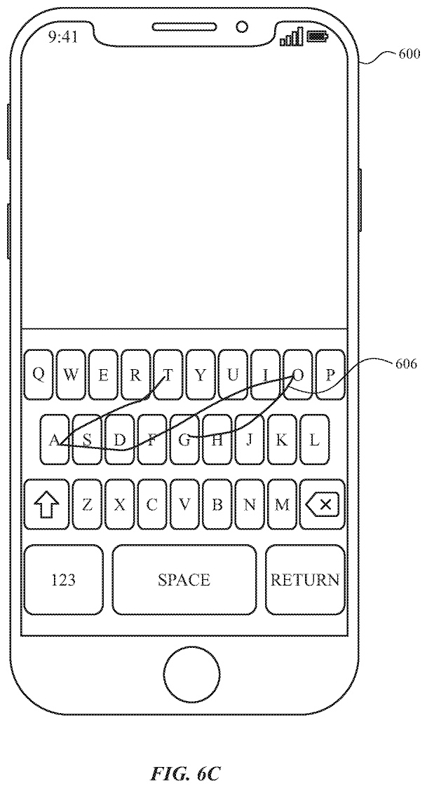

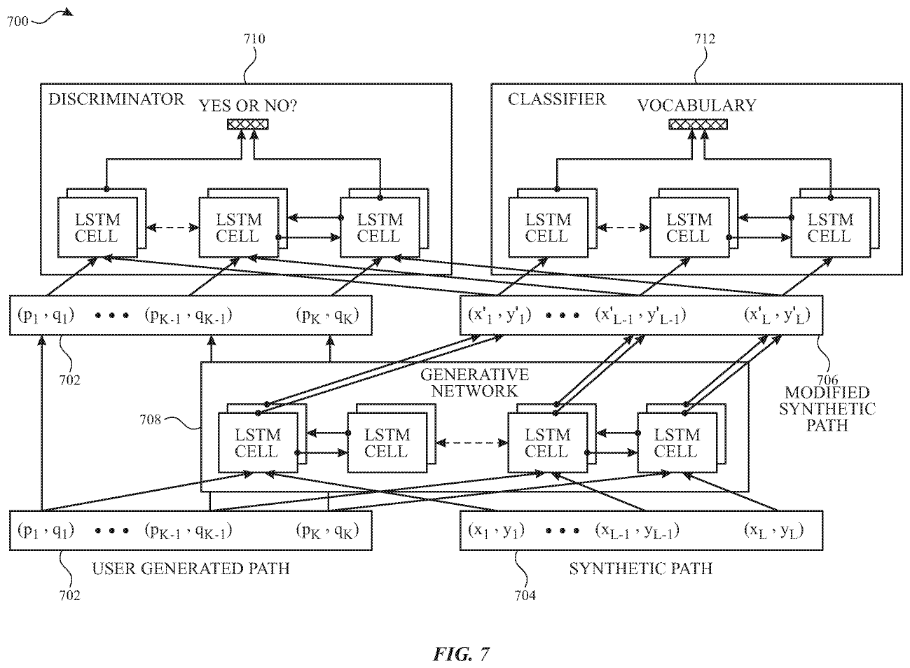

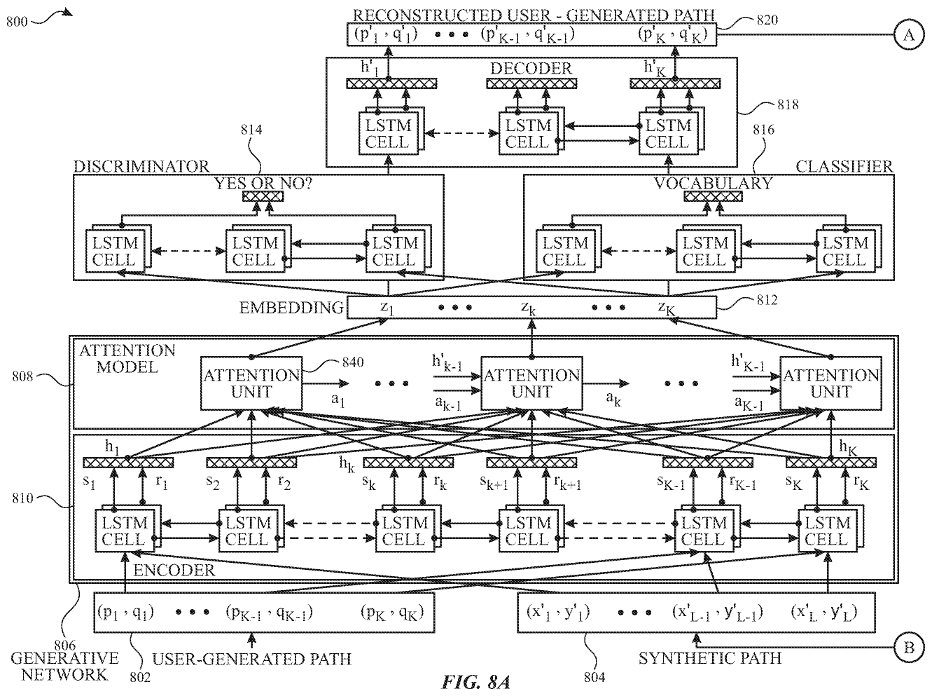

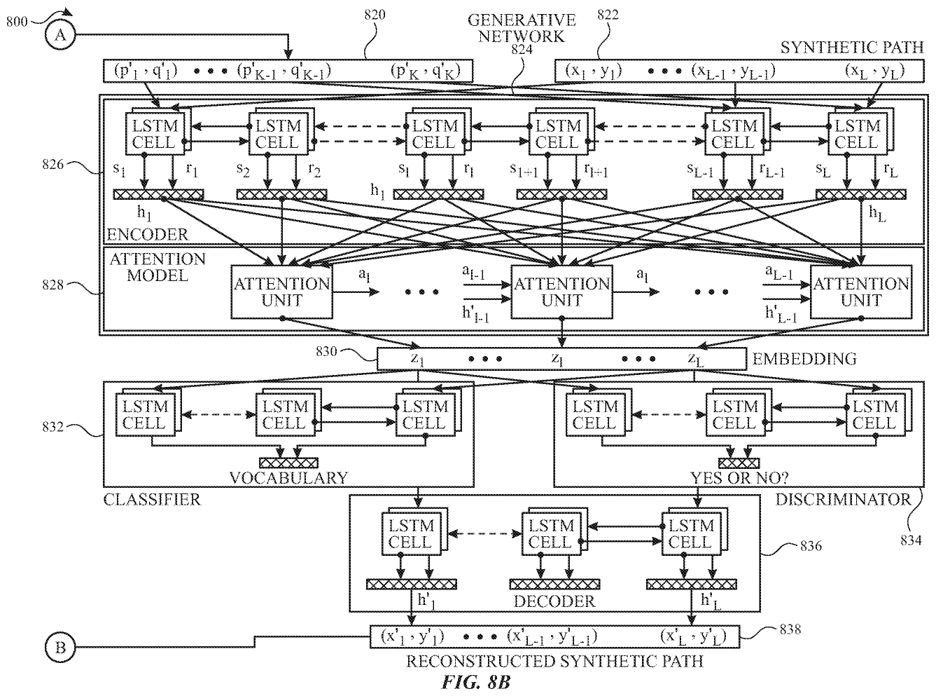

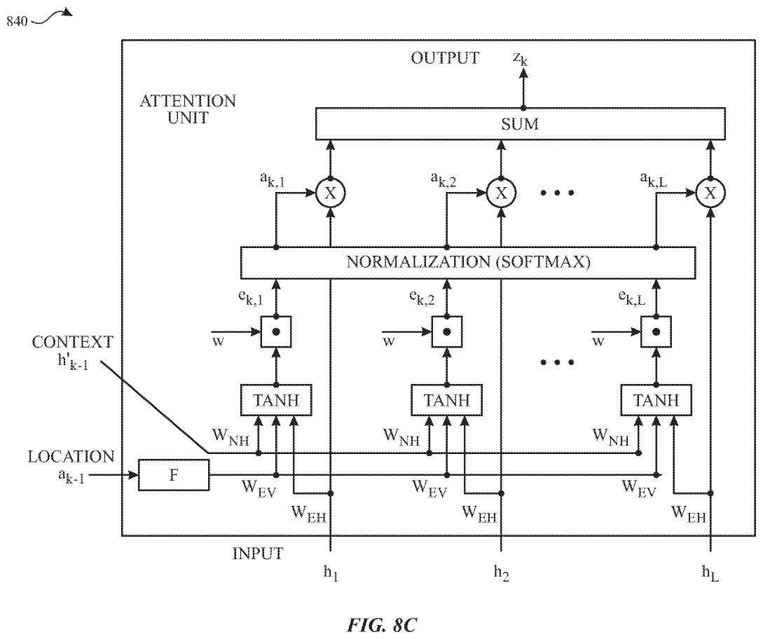

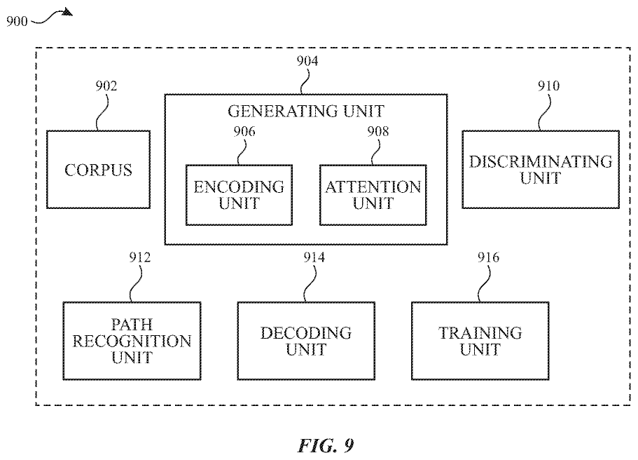

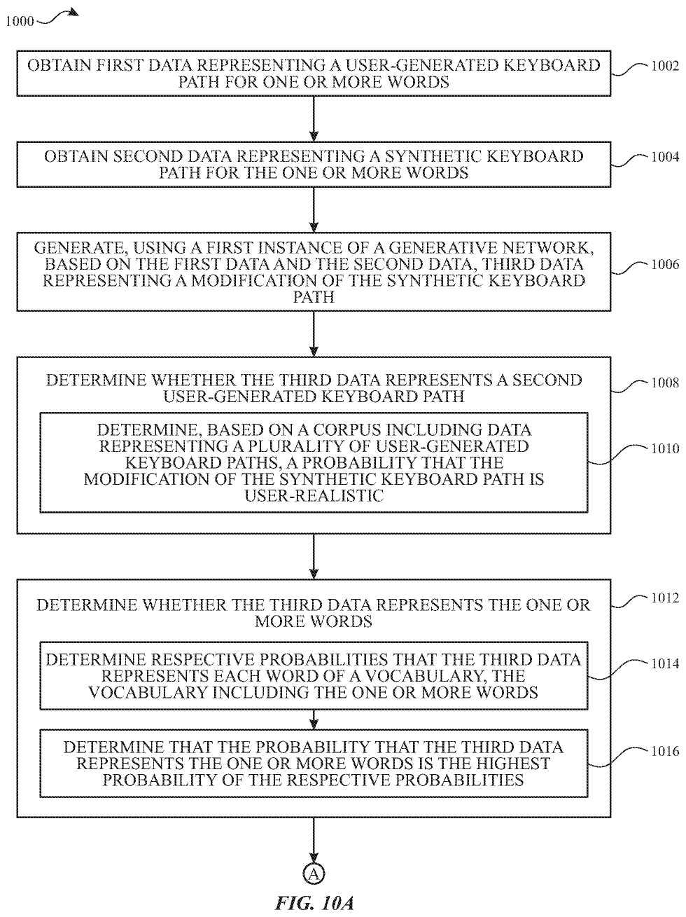

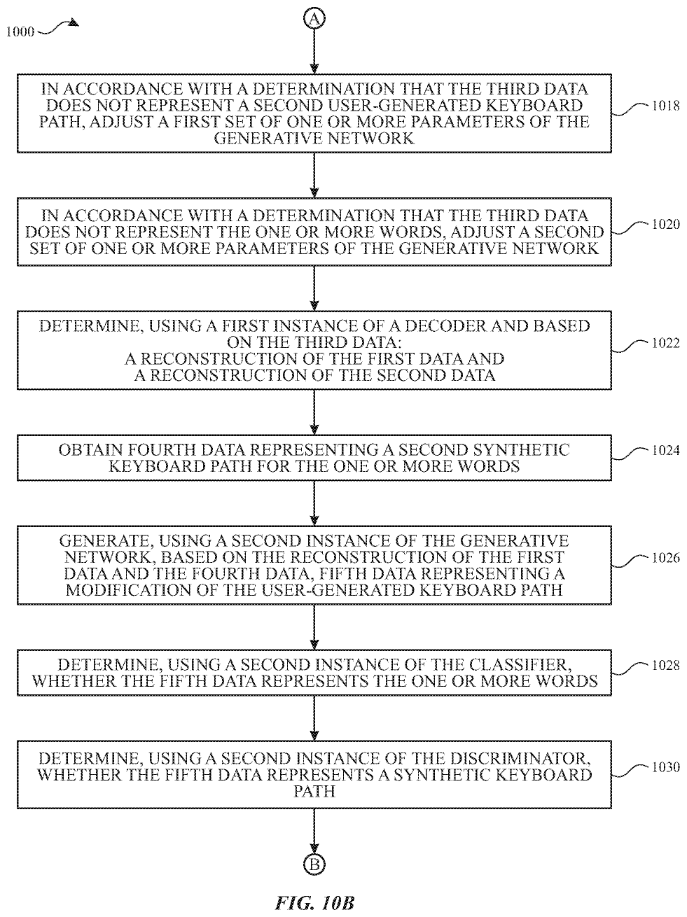

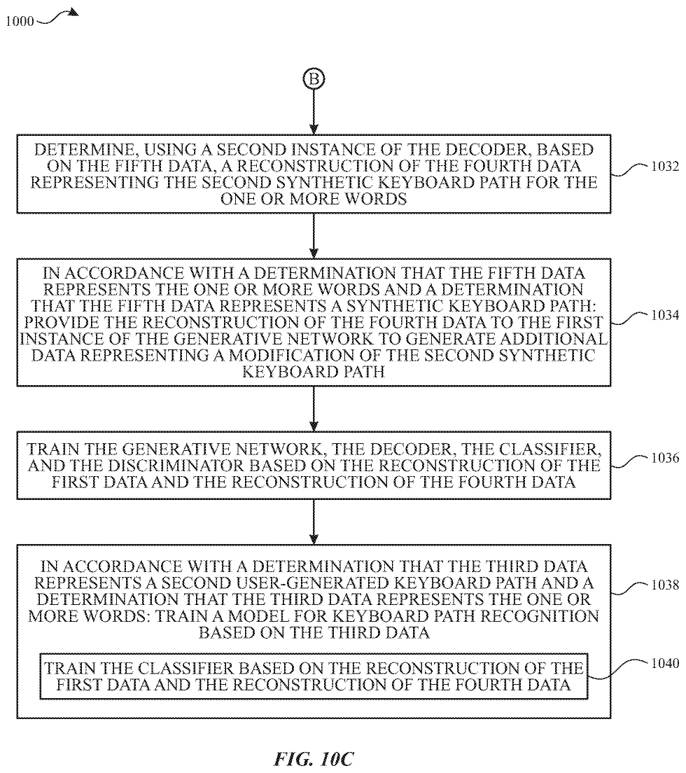

Below, FIGS. 1A-1B, 2, 3, 4A-4B, and 5A-5B provide a description of exemplary devices for performing the techniques for generating and recognizing keyboard paths. FIGS. 6A-C illustrate various keyboard paths. FIG. 7 illustrates an exemplary system for keyboard path generation. FIGS. 8A-C illustrate an exemplary system for keyboard path generation and recognition. FIG. 9 illustrates an exemplary system for generating and recognizing keyboard paths and for training models for keyboard path recognition FIGS. 6A-C, 7, 8A-C, and 9 are used to describe the processes described below, including the process of FIGS. 10A-C.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

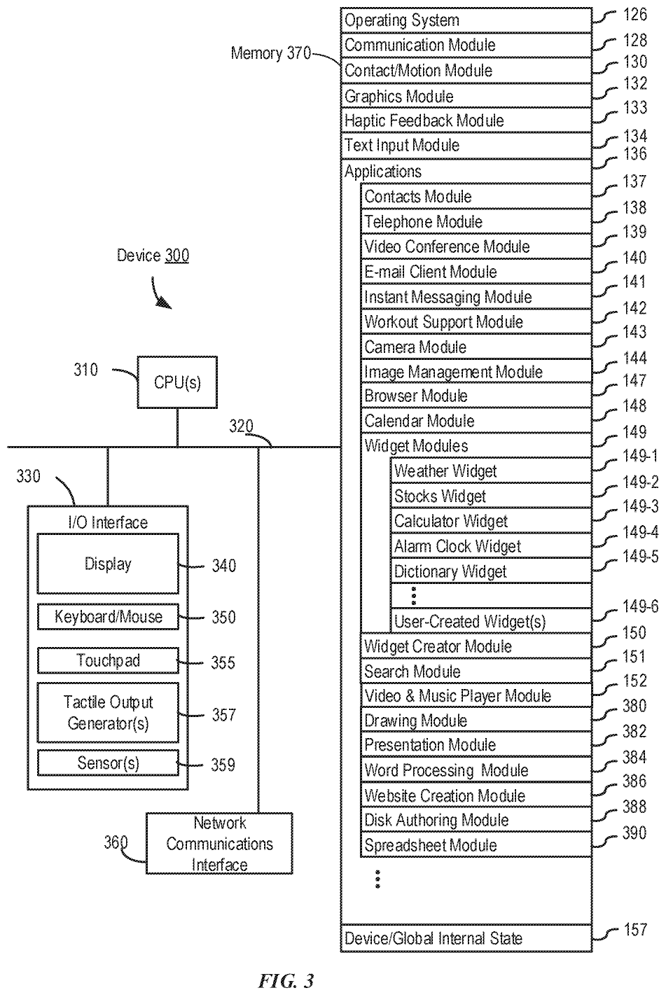

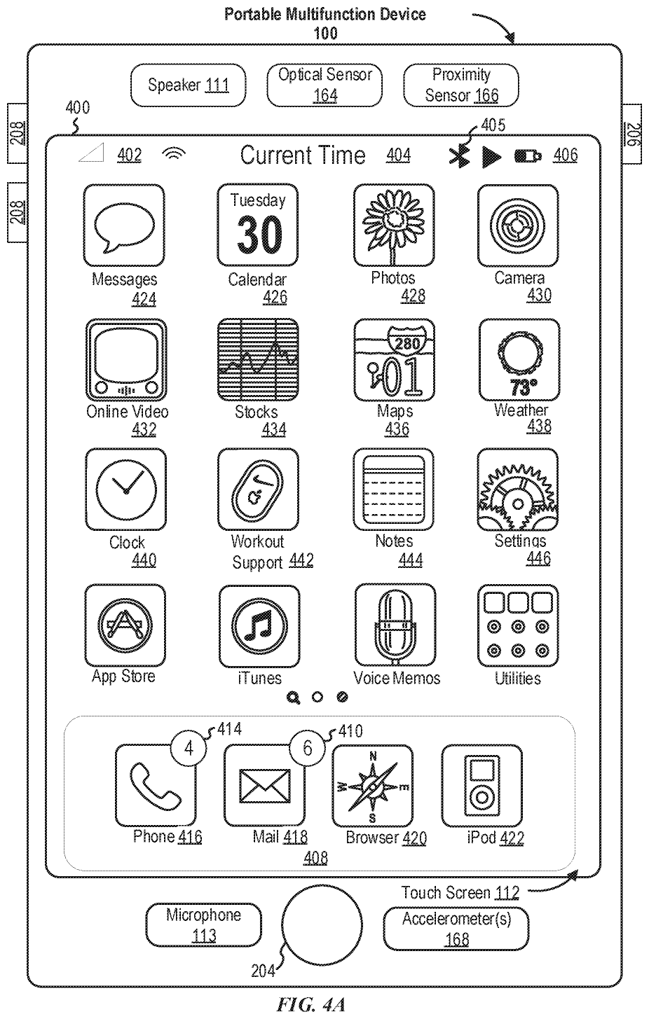

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod@ (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module,
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

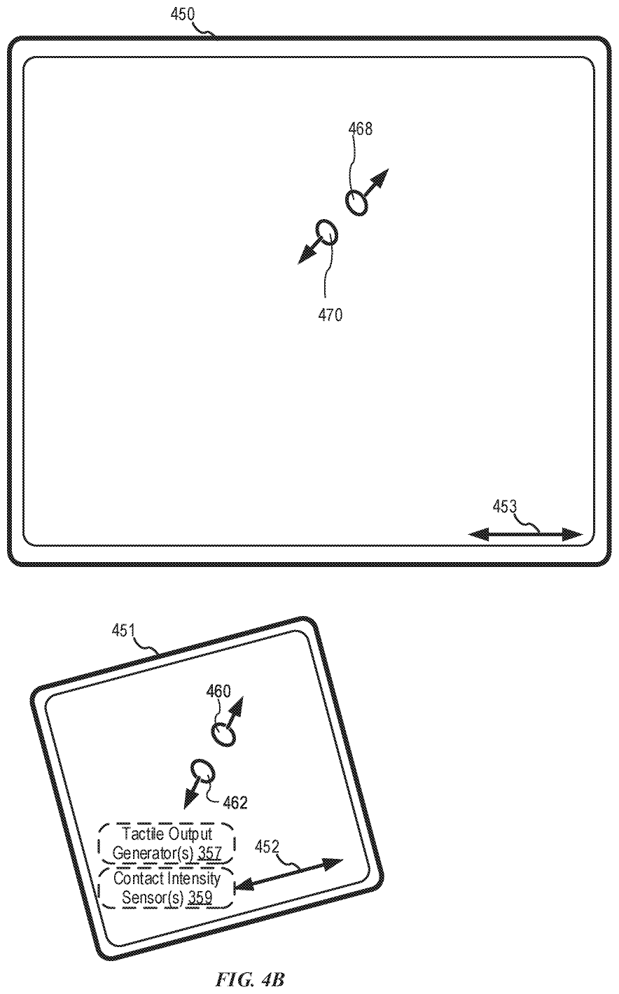

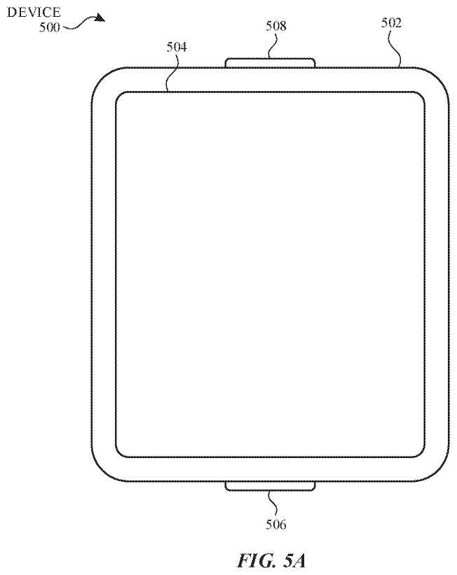

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals:
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for I module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

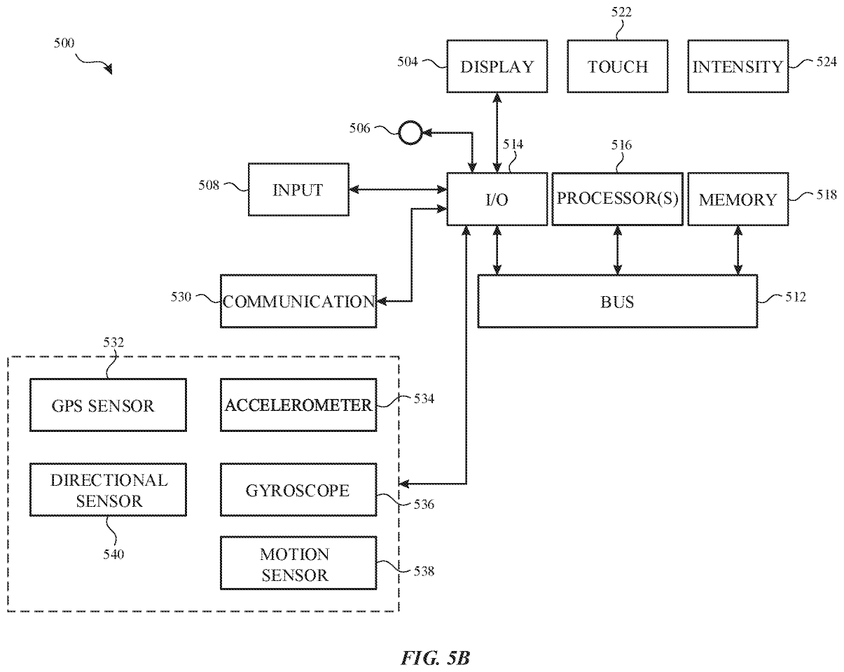

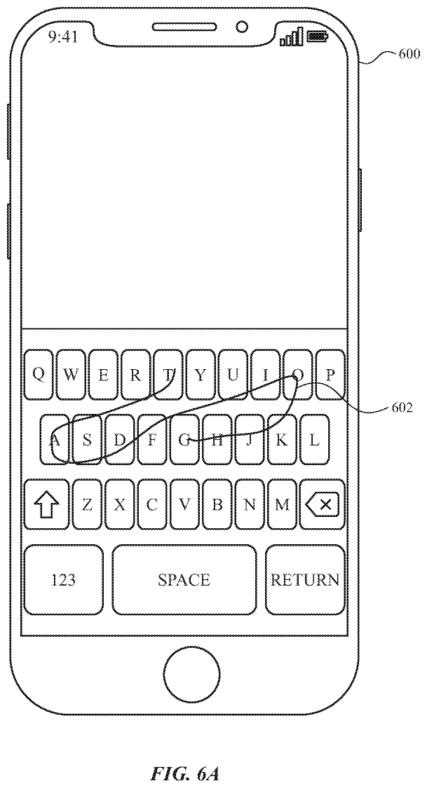

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 1000 (FIGS. 10A-C). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

FIGS. 6A-C illustrate various keyboard paths on a displayed keyboard of device 600. Device 600 is the same as or similar to devices 100, 300, or 500 discussed above.

FIG. 6A illustrates a user-generated keyboard path 602, according to some embodiments. For example, FIG. 6A illustrates a human inputted keyboard path for the word “GOAT.” A user-generated path includes features characteristic of a user-generated path (user-realistic features). Such features include, for example, path excursions (e.g., the path between consecutive characters, such as “G” and “O,” is not direct), overshoots (e.g., the path extends past an intended character), undershoots (e.g., the path does not reach an intended character), smooth edges near or on intended characters, or a combination or sub-combination thereof.

User-generated paths may provide suitable training data for path recognition models. However, collecting enough user-generated paths for a sufficiently large training data set can be difficult and/or expensive, e.g., requiring many human users to generate paths and annotate the paths with the correct word(s) or requiring many human users to generate paths for predetermined words. Further, collecting paths from users' personal devices may raise privacy concerns, as such paths may indicate users' personal text communications. Thus, it can be desirable to train path recognition models based on synthetic keyboard paths.

FIG. 6B illustrates a synthetic keyboard path 604 for the word “GOAT,” according to some embodiments. A computing device (e.g., device 100, 300, 500, or 600), not a human user, generates a synthetic keyboard path. As shown, a synthetic keyboard path may not include user-realistic features. For example, a synthetic keyboard path may include limited to no path excursions (e.g., the path between “G” and “O” is direct), limited to no overshoots, or limited to no undershoots.

Compared to user-generated paths, synthetic paths may be relatively easy and inexpensive to generate. However, because synthetic paths may not include user-realistic features, training a model to recognize user-inputted paths based solely on such synthetic keyboard paths may yield unsatisfactory results. Thus, it may be desirable to modify synthetic paths to appear user-realistic (e.g., modify to include user-realistic features) and train a path recognition model based on such modified paths.

FIG. 6C illustrates a modified synthetic keyboard path 606 for the word “GOAT,” according to some embodiments. In FIG. 6C, synthetic path 604 is modified based on user-generated path 602 to appear more user-realistic. Sufficiently user-realistic modified paths may then be used to train a path recognition model. Techniques for generating modified paths and determining whether the modified paths are sufficiently user-realistic are discussed below with respect to FIGS. 7 and 8A-C.

One of skill in the art will appreciate that training a path recognition model based on modified paths may have numerous advantages. For example, because modified paths are determined from synthetic paths (which are relatively easy and inexpensive to generate compared to collecting actual user paths), a large amount of modified paths may be used as training data for a path recognition model, which may result in a more accurate and efficient path recognition model. Further, training a path recognition model in such manner may improve user privacy by reducing or eliminating collection of user-generated keyboard paths from users' personal devices.

FIG. 7 illustrates system 700 for keyboard path generation, according to some embodiments. In some embodiments, system 700 is implemented on one or more electronic devices (e.g., 100, 300, 500, or 600) and the components and functions of system 700 may be distributed in any manner between the devices. In some embodiments, system 700 is implemented on one or more server devices having architectures similar to or the same as devices 100, 300, 500, or 600 (e.g., processors (CPU(s), GPU(s)), network interfaces, controllers, and memories) but with greater memory, computing, and/or processing resources than devices 100, 300, 500, or 600. System 700 is implemented using hardware, software, or a combination of hardware and software to carry out the principles discussed herein. Further, system 700 is exemplary, and thus system 700 can have more or fewer components than shown, can combine two or more components, or can have a different configuration or arrangement of the components. Further, although the below discussion describes functions being performed at a single component of system 700, it is to be understood that such functions can be performed at other components of system 700 and that such functions can be performed at more than one component of system 700.

System 700 includes generative network 708. Generative network 708 determines modifications of synthetic keyboard paths (modified paths) so the modified paths appear user-realistic. In some embodiments, generative network 708 includes one or more bi-directional recurrent neural networks (RNNs). In some embodiments, the nodes of the RNN(s), such as the hidden nodes, are implemented as long short-term memory (LSTM) cells. Although FIG. 7 shows two layers of LSTM cells, one of skill in the art will appreciate that each LSTM cell may be extended to form a deeper network, and thus that any number of LSTM layers and/or cells may be employed.

In some embodiments, data representing a user-generated keyboard path 702 for one or more words are obtained and inputted into generative network 708. As used herein, a “word” refers to a sequence of characters, e.g., including acronyms, misspellings, slang, and the like. In some embodiments, data representing user-generated paths are obtained from a corpus (e.g., stored in the memories of devices 100, 300, 500, or 600) including data representing a plurality of user-generated paths. In some embodiments, the plurality of user-generated paths are obtained from human users (e.g., volunteers) who have generated a limited number of keyboard paths.

Data representing a user-generated keyboard path P indicate various information associated with the path. In some embodiments, the data include a sequence of M-dimensional feature vectors {fₖ} for the path P. The sequence of feature vectors {fₖ} indicates, for example, a sequence of spatial coordinates P={(p₁, q₁) . . . (p_{K}, q_{K})} forming the path. In some embodiments, the sequence of feature vectors additionally indicates the keyboard characters corresponding to the path, the time since a previous keyboard path was inputted, the type(s) of gesture (e.g., finger down press, finger swipe through, or finger up lift) corresponding to respective portions of the path, or a combination or sub-combination thereof.

In some embodiments, data representing a synthetic keyboard path 704 for the same one or more words (e.g., “GOAT”) as the user-generated keyboard path are obtained and inputted into generative network 708. In some embodiments, data representing synthetic keyboard paths are obtained from a corpus including data representing a plurality of synthetic keyboard paths. As discussed, the corpus may include a large amount of synthetic keyboard paths, as such paths are relatively easy and inexpensive to generate.

In some embodiments, data representing a synthetic keyboard path X indicate the same or similar information as data representing a user-generated keyboard path. For example, the data representing a synthetic keyboard path include a sequence of M-dimensional feature vectors for the path X. The sequence of feature vectors indicates, in some embodiments, a sequence of spatial coordinates X={(x₁, y₁) . . . (X_{L}, y_{L})} forming the path. In some embodiments, the sequence of feature vectors additionally indicates other information associated with path X, e.g., as discussed above with respect to path P.

In some embodiments, generative network 708 generates data representing a modification of the synthetic keyboard path 706. In some embodiments, the modified synthetic path Y is formed by a sequence of spatial coordinates Y=((x′₁, y′₁) . . . (x′_{L}, y′_{L})) included in the data. In some embodiments, generative network 708 generates the data based on the data representing a user-generated keyboard path for one or more words 702 and the data representing a synthetic keyboard path for the one or more words 704. Thus, in some embodiments, generative network 708 transforms the synthetic path X into a more user-realistic path Y based on a corpus of user-generated paths {P} including information representing user-realistic path features. For example, generative network 708 shifts one or more coordinates of the input synthetic path X (e.g., FIG. 6B) to generate a more user-realistic path Y (e.g., FIG. 6C).

System 700 includes discriminator 710. Discriminator 710 determines whether input data representing modifications of synthetic keyboard paths represent a user-generated (user-realistic) path. In some embodiments, the architecture of discriminator 710 is similar to that of generative network 708. For example, discriminator 710 includes one or more bi-directional RNNs, where the hidden nodes of the RNN are implemented as LSTM cells. Although two layers of LSTM cells are shown, each LSTM cell may be extended to form a deeper network, and thus any number of LSTM layers and/or cells may be employed in discriminator 710.

Discriminator 710 accepts either data representing a user-generated path P or data representing a modified synthetic path Y and determines whether the input data represent a user-generated path. Discriminator 710 and generative network 708 thus form a generative adversarial network (GAN), where generative network 708 functions as the generator G and discriminator 710 functions as the discriminator D. Such GAN architecture may promote the generation of user-realistic paths, as discriminator 710 learns to identify user-realistic path features from corpus {P} (e.g., to determine whether a path is user-realistic) and causes generative network 708 to generate user-realistic modified paths (e.g., based on user-realistic path features observed in corpus {P}). For example, if discriminator 710 determines that generated data does not represent a user-realistic path, discriminator 710 causes generative network 708 to discard the generated data and to adjust one or more parameters (e.g., weight matrices) of the generative network.

System 700 includes classifier 712. In some embodiments, classifier 712 recognizes paths to determine whether input data representing a modification of a synthetic path represent the same one or more words as the synthetic path. Because classifier 712 can recognize paths, in some embodiments, classifier 712 is a model for keyboard path recognition. In some embodiments, the architecture of classifier 712 is similar to that of generative network 708 and/or that of discriminator 710. For example, classifier 712 includes one or more bi-directional RNNs, where the hidden nodes of the RNN are implemented as LSTM cells. Although two layers of LSTM cells are shown, it will be appreciated that any number of LSTM cells/layers may be employed in classifier 712.

Using classifier 712 to determine whether a modified synthetic path represents the same word(s) as the synthetic path may prevent generative network 708 from modifying the synthetic path X into a path Y for a different word. For example, if classifier 712 determines that data representing a generated path Y does not represent the same word as the synthetic path, classifier 712 causes generative network 708 to discard the data and to adjust one or more parameters (e.g., weight matrices) of the generative network. Determining that a modified path still represents the same word may advantageously prevent loss of discriminability between words. For example, the synthetic path for “GOAT” in FIG. 6B may be modified to a user-realistic path for “HOST,” whose characters are close to the characters for “GOAT.” Such a modified path may be incorrect training data for an intended word, e.g., “GOAT.”

In view of the above, in some embodiments, generated data representing modifications of paths are inputted to both discriminator 710 and classifier 712. This way, in some embodiments, generative network 708, discriminator 710, and classifier 712 are jointly trained so classifier 712 learns to determine if a path represents a correct word, discriminator 710 learns to determine if the path is user-realistic, and generative network 708 learns to generate paths that are both user-realistic and that represent a correct word. In some embodiments, a model for keyboard path recognition is trained based on data representing paths that are both user-realistic and for a correct word, e.g., using supervised learning techniques known to those of skill in the art.

Techniques for generative network 708 to generate paths, for discriminator 710 to determine whether a path is user-realistic, and for classifier 712 to recognize paths based on their respective inputs are now discussed in greater detail.

As shown in FIG. 7, in some embodiments, generative network 708, discriminator 710, and classifier 712 each include LSTM cells and accept data representing path(s) as input. As discussed, data representing a path can include a sequence of feature vectors for the path (e.g., {fₖ} for path P). In some embodiments, the feature vectors are processed using step-wise global contrast normalization (e.g., removing the mean and dividing by the standard deviation of the feature vectors) prior to being inputted into the various networks 708, 710, or 712.

After data representing a path is inputted into the LSTM cells of network 708, 710, or 712, the hidden node activations of the respective networks are computed. Because in some embodiments, the respective architectures of networks 708, 710, and 712 are each bi-directional, there is both left context and right context for a particular path. For example, for path P and network 708, the H-dimensional vector sₖ₋₁ includes the internal representation of context obtained from the outputs of the hidden layer(s) from a previous time step. Similarly, for path P and network 708, the H-dimensional vector rₖ₊₁ includes the internal representation of context obtained from the outputs of the hidden layer(s) from a future time step. Thus, for a user-generated path P, the hidden node activations of network 708 are computed as:

sₖ=T{W_{SF}·fₖ+W_{SS}·sₖ₋₁}, (1)

rₖ=T{W_{RF}·fₖ+W_{RR}·rₖ₊₁}, (2)

where the matrices W. are suitable weight matrices of compatible dimensions and T{⋅} denotes an activation function, such as a sigmoid, hyperbolic tangent, or a rectified linear unit. Respective equations similar to equations (1) and (2) apply for a synthetic path X and a modified synthetic path Y. Respective equations similar to equations (1) and (2) also apply for computing the hidden node activations of networks 710 and 712.

As discussed, generative network 708 generates data representing a modified synthetic path. For example, generative network 708 outputs a sequence ofM-dimensional feature vectors representing a modified synthetic path based on computed hidden node activations. In some embodiments, these feature vectors are obtained from a concatenation of forward and backward (e.g., left and right) hidden states of network 708 at a current time step according to:

gₗ=S{W_{GS}·[sₗrₗ]}, (3)

where S{⋅} denotes the softmax activation function and the subscript l indicates a synthetic path. In some embodiments, generative network 708 determines the modified synthetic path Y={(x′₁, y′₁) . . . (x′_{L}, y′_{L})} from the sequence of feature vectors (gₗ).

As discussed, discriminator 710 determines whether data representing a path represent a user-generated path. For example, discriminator 710 outputs a probability that a path (e.g., modified path Y) is user-realistic based on computed hidden node activations. In some embodiments, discriminator 710 determines the probability based on user-realistic path features, e.g., represented by parameters of discriminator 710 learned from a corpus of user-generated paths. In some embodiments, discriminator 710 determines the probability after it processes all coordinates of an input path using the LSTM cells. In some embodiments, the probability q is encoded as a binary vector and determined according to:

q=S{W_{QU}·[u_{K}v₁]}, (4)

where K is replaced with L if the input path is user-generated, and uₖ and vₖ are the respective forward and backward states of discriminator 710, analogous to the forward and backward states sₖ and rₖ of generative network 708. In this manner, discriminator 710 determines a probability that a modified synthetic path is user-realistic based on a corpus including data representing user-generated paths. In some embodiments, discriminator determines that the modified synthetic path is user-realistic by comparing the probability to a threshold (e.g., 0.5, 0.75, 0.95).

As discussed, classifier 712 determines whether data representing a path represent a particular word. For example, classifier 712 outputs a vector including respective probabilities that an input path represents each word in a vocabulary based on the computed hidden node activations of the classifier. In some embodiments, the vocabulary includes a plurality of words that classifier 712 is configured to recognize. In some embodiments, the vector has dimension N, where N is the number of words included in the vocabulary. In some embodiments, classifier 712 determines the vector after it processes all coordinates of an input path using the LSTM cells according to:

w=S{W_{QD}·[d_{L}e₁]}, (5)

where dₗ and eₗ are the respective forward and backward states of classifier 712, analogous to uₖ and vkof discriminator 710. The index j of the maximum output value wⱼ thus corresponds to most likely word represented by the input path, e.g., path Y. In this manner, in some embodiments, classifier 712 determines whether data representing a path corresponds to a particular word by determining respective probabilities that the data corresponds to each word of a vocabulary, and by determining that the probability that the data corresponds to the particular word is the highest probability of the respective probabilities.

Techniques for training the various components of system 700 are now discussed.

In some embodiments, generative network 708 is trained to generate data representing modifications of keyboard paths, where the data have a probability distribution D′ corresponding to a probability distribution D of data representing user-generated keyboard paths included in a corpus. For example, generative network 708 is trained such that D′ converges to 1) according to a suitable closeness metric. Training generative network 708 in this manner may thus allow generation of sufficiently user-realistic paths for use as training data for a path recognition model.

In some embodiments, to train generative network 708 in this manner, consider that the generative network (generator G) transforms an input synthetic path X into a modified pathY=G(A) based on a user-generated path P so that Y conforms of the user-realistic features of P. As discussed, in some embodiments, discriminator 710 (e.g., discriminator [symbol] ) then determines a probability that the modified path is user-realistic, e.g., a probability that the input path is drawn from D rather than D′. Thus, in some embodiments, the training constraints are that D(P)=1 when P˜D, that D(Y)=0 whenY˜D′, and that Y≈X. These constraints correspond to a minimax two player game, where, in some embodiments, generator G and discriminator D are jointly trained by optimizing the cost function K(D, G), corresponding to both the generator and the discriminator, according to:

$${min}_{G} {max}_{𝒟} 𝒦 ( 𝒟 , G ) = {E}_{P ∼ D} \{ log [ 𝒟 ( P ) ] \} + {E}_{G ( X ) ∼ {D}^{′}} \{ log [ 1 - 𝒟 ( G ( X ) ) ] \} + {E}_{G ( X ) ∼ {D}^{′}} \{ Δ [ X , G ( X ) ] \} , \qquad ( 6 )$$

where Δ[X, G(X)] is a suitable distance metric that is 0 when X=Y and that increases from 0 as X and Y become more dissimilar. Maximizing equation (6) over while D minimizing over G allows for the generative network to generate paths Y that are as similar to the synthetic path X as possible, but that appear to be drawn from the distribution D of user-generated paths. In some embodiments, after enough training iterations, training generator G and discriminator D according to equation (6) allows for D′ (the probability distribution of data generated by network 708) to converge to D.

In some embodiments, the cost function K(D, G) is optimized by alternating two gradient updates. Specifically, at a training iteration i, the following two steps are performed:

Φᵢ₊₁=Φᵢ+αᵢ·∇_{Φ}K(Dᵢ,Gᵢ), (7)

Ψᵢ₊₁=Ψᵢ−αᵢ·∇_{Ψ}K(Dᵢ₊₁,Gᵢ), (8)

where Φᵢ and Ψᵢ are the respective current parameters of D and G and αᵢ is a current learning rate.

In some embodiments, training classifier 712 (classifier C) similarly involves optimizing a respective cost function [symbol] (C), e.g., by reducing [symbol] (C) at each training iteration. Because, in some embodiments, recognizing a word (e.g., represented by wⱼ in equation (5)) involves mapping a sequence of feature vectors representing a path to a sequence of characters, a suitable cost function for such mapping may be the Connectionist Temporal Classification (CTC) loss. In some embodiments, optimizing the CTC loss function allows training of RNNs by maximizing the sum of probabilities for all step-wise sequences (e.g., the sequences “G,” “GO,” and “GOA”) corresponding to a target sequence (e.g., the word “GOAT”). In some embodiments, the CTC loss function is:

[symbol]

(C)=−log(Σ_{π∈A(w)}Πₖ₌₁^{K}oₖ^{(π)}), (9)

where w is the target sequence, A(w) is the set of all CTC sequences of a target sequence (e.g., for the word “data,” the CTC sequences may include “daata,” “datta,” “dddata,” and the like), and oₖ^{(π)} denotes the output of the LSTMs of classifier 712 at time step k for a particular CTC sequence r of the target sequence. In some embodiments, computing and/or optimizing the CTC loss includes inserting one or more blank characters (e.g., spaces) at the beginning, between each character, and at the end of a target sequence. In some embodiments, the forward-backward algorithm is then used to extract all possible CTC sequences π of the target sequence.

In some embodiments, training system 700 includes jointly training generative network 708, discriminator 710, and classifier 712 according to the above discussed techniques. For example, to train system 700, the following cost function M, a linear interpolation of equations (6) and (9), is optimized (e.g., reduced at each training interation):

M(C, [symbol] ,G)=λ·K( [symbol] ,G)+(1−λ)· [symbol] (C), (10)

where the scalar coefficient λ is a tunable weighting parameter that adjusts the contribution from the GAN (e.g., generator G and discriminator [symbol] ) and the classifier C. Training system 700 in this manner may allow for generation of modified paths that are both user-realistic and that represent a correct word.

As discussed, an objective of generating user-realistic modified paths may be to provide enough data to train an accurate path recognition model. Thus, prior to the training, or during early training iterations, a path recognition model (e.g., classifier 712) may be insufficiently accurate. Further, it may be unlikely to train such path recognition model to be sufficiently accurate based solely on the limited number available of user-generated paths. Accordingly, one option to train the path recognition model according to the above-discussed techniques is to proceed iteratively. For example, generative network 708 may initially generate a set of modified paths determined by a (potentially insufficiently trained) classifier to be for correct words, a more accurate classifier may be trained based on the set of modified paths, generative network 708 may then generate a larger set of modified paths determined by the more accurate classifier to be for correct words, an even more accurate classifier may be trained based on the larger set of modified paths, and so on. However, it may be desirable for techniques and systems to consolidate these training, generation, and recognition (classification) processes. Such techniques are discussed below with respect to FIGS. 8A-C.

FIGS. 8A and 8B illustrate system 800 for keyboard path generation and recognition, according to some embodiments. In some embodiments, system 800 is implemented on one or more electronic devices (e.g., 100, 300, 500, or 600) and the components and functions of system 800 may be distributed in any manner between the devices. In some embodiments, system 800 is implemented on one or more server devices having architectures similar to or the same as devices 100, 300, 500, or 600 (e.g., processors (CPU(s), GPU(s)), network interfaces, controllers, and memories) but with greater memory, computing, and/or processing resources than devices 100, 300, 500, or 600. System 800 is implemented using hardware, software, or a combination of hardware and software to carry out the principles discussed herein. Further, system 800 is exemplary, and thus system 800 can have more or fewer components than shown, can combine two or more components, or can have a different configuration or arrangement of the components. Further, although the below discussion describes functions being performed at a single component of system 800, it is to be understood that such functions can be performed at other components of system 800 and that such functions can be performed at more than one component of system 800.

As discussed below, similar to system 700, system 800 modifies synthetic paths to appear user-realistic. However, system 800 further modifies user-generated paths to appear synthetic, allowing generation of new synthetic paths for training data. Using this cyclical technique for generating paths, a large amount of training data may be generated from a limited number of user-generated annotated paths included in a corpus. Further, the below techniques may allow for a model for path recognition to be trained concurrently with other components of system 800, advantageously consolidating the various training processes.

System 800 includes first instance of generative network 806. In some embodiments, first instance of generative network 806 accepts data representing a user-generated path P for one or more words 802 and data representing a synthetic path X for the one or more words 804 as input. Data representing a path may indicate various information associated with the path, e.g., the coordinates forming the path, as discussed with respect to FIG. 7. In some embodiments, the data representing a synthetic path include a reconstruction of data representing the synthetic path, discussed further below.

In some embodiments, generative network 806 generates data representing a modified synthetic path Y based on the input data. In some embodiments, the data representing the modified synthetic path Y include an embedding 812 of the modified path. Embedding 812 includes a sequence of vectors {z₁ . . . z_{K}} indicating information associated with the path. In some embodiments, embedding 812 is determined using a first instance of an encoder 810 and a first instance of an attention model 808, discussed below. In this manner, similar to generative network 708, generative network 806 may modify synthetic paths to appear user-realistic.

Generative network 806 includes a first instance of an encoder 810. In some embodiments, encoder 810 is the same as or similar to generative network 708 discussed with respect to FIG. 7. For example, encoder 810 includes one or more RNNs implemented using one or more layers of LSTM cells that accept data representing paths as input. As shown, in some embodiments, for a particular input path, encoder 810 computes its hidden node activations hₖ=[sₖ, rₖ] using equations (1) and (2) (or similar equations). Encoder 810 then provides its computed hidden node activations to first instance of attention model 808.

Generative network 806 includes a first instance of attention model 808. Attention model 808 generates embedding 812 based on computed hidden node activations provided by encoder 810. In some embodiments, attention model 808 determines information representing an alignment between a portion of a modified path and a corresponding keyboard character. For example, attention model 808 determines information indicating that portions of a modified path (e.g., the vertex/corner near the character “O” in FIG. 6C) are aligned with respective characters (e.g., “O”). In some embodiments, such information is included in embedding 812.

Attention model 808 includes a plurality of attention units 840 configured to generate embedding 812. In some embodiments, at a particular time step k, attention units 840 generate embedding zₖ using a weighted sum of provided hidden node activations hₗ:

zₖ=Σₗ₌₁^{L}α_{k,l}·hₗ, (11)

where aₖ=[α_{k,1} . . . α_{k,L}] is the attention probability vector at time step k. In some embodiments, each element α_{k,l} of aₖ is computed according to:

$${α}_{k , l} = \frac{exp ( {e}_{k , l} )}{{Σ}_{{l}^{′} = 1}^{L} exp ( {e}_{k , {l}^{′}} )} , l = 1 , … , L . \qquad ( 12 )$$

Techniques for computing the quantity e_{k,l} are now discussed.

In some embodiments, attention model 808 has positional awareness by considering the alignment aₖ₋₁ from a previous output time-step. Thus, computing e_{k,l} to include positional awareness may include first computing multiple vectors v_{k,l} for each position l of the previous alignment aₖ₋₁ by convolving the previous alignment with a weight matrix F according to:

v_{k,l}=Σ_{l′=l-λ}^{l+λ}F_{l-l′}·α_{k-1,l′}, (13)

where λ controls the size of the attention window 2λ+1 around position l. The quantity e_{k,l} is then computed by attention model 808 according to:

e_{k,l}=w^{T}·T{W_{NH}·hₖ₋₁′+W_{EH}·hₗ+W_{EV}·v_{k,l}},l=1, . . . L, (14)

where the weight vector w and the weight matrices W. have compatible dimensions, and where the activation function T may be a hyperbolic tangent. FIG. 8C, showing an exemplary attention unit 840, illustrates the aforementioned process for generating embedding 812.

Returning to FIG. 8A, system 800 includes first instance of discriminator 814. Discriminator 814 accepts data representing a path (e.g., an embedding) as input and determines whether the data represent a user-generated keyboard path. Discriminator 814 is the same as or similar to discriminator 710 discussed above. For example, discriminator 814 includes one or more layers of LSTM cells that accept data representing paths as input and that are used to determine whether the data represent a user-generated path according to the techniques discussed above.

System 800 includes first instance of classifier 816. Classifier 816 recognizes path inputs and may thus be a path recognition model. For example, classifier 816 determines whether input data representing a modification of a synthetic path (e.g., embedding 812) represent the same one or more words as the synthetic path 804. Classifier 816 is the same as or similar to classifier 712 discussed above. For example, classifier 816 include one or more layers of LSTM cells that accept data representing paths as input and that are used to recognize paths according to the techniques discussed above.

As shown in FIG. 8A, in some embodiments, generated data representing a modification of a synthetic keyboard path is inputted to both discriminator 814 and classifier 816. In this manner, as discussed, generative network 806, discriminator 814, and classifier 816 may be trained to more accurately perform their respective functions.

System 800 includes first instance of decoder 818. First instance of decoder 818 accepts data representing a modified synthetic path as input and attempts to reconstruct the paths, e.g., paths 802 and 804, used to determine the data. For example, decoder 818 decodes embedding 812 to determine a reconstruction of the data representing a user-generated path for a word and to determine a reconstruction of the data representing a synthetic path for the word. In some embodiments, the reconstruction of the data representing a user-generated path P includes a set of coordinates P′={(p′₁,q′₁) . . . (p′_{K},q′_{K})} forming the reconstructed user-generated path 820 and/or a sequence of feature vectors for path P′. Similarly, in some embodiments, the reconstruction of the data representing a synthetic path X includes a set of coordinates X={(x′₁,y′₁) . . . (x′_{L},y′_{L})} forming the reconstructed synthetic path and/or a sequence of feature vectors for path X′. In this manner, decoder 818 attempts to recover the user-generated path and the synthetic path used to determine embedding 812. In some embodiments, such reconstructed paths are used as additional training data for the components of system 800.

In some embodiments, decoder 818 includes one or more RNNs where the nodes (e.g., hidden nodes) of decoder 818 are implemented as LSTM cells. Although FIG. 8A shows two layers of LSTM cells, each LSTM cell/layer may be extended to form a deeper network, and thus any number of LSTM cells may be employed. In some embodiments, the LSTM cells accept embedding 812 as input and compute the hidden node activations using, for example, equations similar to equations (1) and (2). In some embodiments, based on the computed hidden node activations, decoder 818 determines reconstructions of data representing paths using, for example, an equation similar to equation (3).

Turning to FIG. 8B, system 800 includes second instance of generative network 824. In some embodiments, second instance of generative network 824 and first instance of generative network 806 are separate instances of the same generative network. For example, the respective architectures of the two networks may be the same. For example, network 824 includes second instances of encoder 826 and attention model 828, respectively similar to or the same as encoder 810 and attention model 808. Further, the parameters (e.g., weights) of the two instances of the generative network may be the same or readily determinable from each other, e.g., using a mathematical function. Thus, training network 806 may also train network 824, and vice-versa.

System 800 further includes second instances of classifier 832, discriminator 834, and decoder 836, where the first instances of the respective components are shown in FIG. 8A. In some embodiments, similar to the two instances of the generative network, the two instances of the classifier, the two instances of the discriminator, and the two instances of the decoder may each be separate instances of the same component. Thus, training any one instance of the classifier, discriminator, or decoder may also train the other instance of the respective component.

In some embodiments, a reconstruction of a user-generated path 820 (e.g., representing path P′) for a word is inputted into generative network 824. In some embodiments, data representing a synthetic path 822 for the same word are obtained, e.g., from a corpus, and also inputted into generative network 824. In some embodiments, generative network 824 generates data, e.g., embedding 830, representing a modification of the user-generated path based on the input data. For example, generative network 824 generates such data using techniques similar to those discussed above with respect to network 806. In this manner, unlike generative network 806 (which may modify a synthetic path to appear user-realistic), generative network 824 modifies a user-generated path (or reconstruction thereof) to appear more synthetic. As discussed, this may allow generation of new synthetic paths from which more user-realistic paths may be generated, increasing the amount of training data available to system 800.

In some embodiments, classifier 832 determines whether input data representing a modification of the user-generated path (e.g., embedding 830) represent the same word as the synthetic path 822. For example, classifier 832 makes such determination using techniques similar to those discussed above with respect to classifier 816.

In some embodiments, discriminator 834 determines whether input data representing a modification of the user-generated path (e.g., embedding 830) represent a synthetic path. For example, discriminator 834 makes such determination using techniques similar to those discussed above with respect to discriminator 814. However, unlike discriminator 814 (which may determine if a modified path represents a user-realistic path), discriminator 834 determines whether a modified path represents a synthetic path. Thus, discriminator 834 and generative network 824 may form a GAN that may promote accurate generation of synthetic paths.

In some embodiments, decoder 836 determines a reconstruction 838 of the data representing the synthetic keyboard path based input data representing a modification of the user-generated path (e.g., embedding 830). For example, decoder 836 determines the reconstruction 838 using techniques similar to those discussed above with respect to decoder 818. In this manner, decoder 836 attempts to recover the synthetic path 822 used to determine embedding 830. In some embodiments, the reconstruction 838 is used as additional training data for the components of system 800.

In some embodiments, in accordance with classifier 832 determining that data representing a modification of the user-generated path represent the same word and in accordance with discriminator 834 determining that the data represent a synthetic path, reconstruction 838 is provided to network 806. In some embodiments network 806 uses reconstruction 838 (e.g., synthetic path 804) to generate additional data representing a modification of the synthetic path 822. In this manner, one cycle of system 800 completes by inputting a reconstructed synthetic path into network 806. Thereafter, the cycle may repeat by network 806 generating additional training data, e.g., by modifying the reconstructed synthetic path to appear more user-realistic, as discussed above.

Techniques for training the various components of system 800, e.g., based on data representing paths (or generated reconstructions thereof) are now discussed.

Similar to generative network 708, generative network 806 (generator G) may transform an input synthetic path X(e.g., path 804) into path Y, where Y is drawn from a distribution D′ corresponding to a distribution D representing user-realistic path features. In some embodiments, discriminator 814 (discriminator [symbol] ) then determines a probability that Y is drawn from D rather than D′. Thus, in some embodiments, the constraints for training the generative network and the discriminator of system 800 are that [symbol] (R)=1 when R˜D and that [symbol] (Y)=0 when Y˜D′. Here, R=G(P) is the embedding (e.g., 830) or wen a user-generated path P (e.g., 820) is modified to appear synthetic and Y=G(X) is the embedding (e.g., 812) for when a synthetic path X is modified to appear user-realistic. These constraints correspond to a minimax two player game, where the generator and discriminator are jointly trained by optimizing the cost function K( [symbol] , G), corresponding to both the generator and the discriminator, according to:

$${min}_{G} {max}_{𝒟} K ( 𝒟 , G ) = {E}_{G ( P ) ∼ D} \{ log [ 𝒟 ( G ( P ) ) ] \} + {E}_{G ( X ) ∼ {D}^{′}} \{ log [ 1 - 𝒟 ( G ( X ) ) ] \} . \qquad ( 15 )$$

In some embodiments, after a sufficient number of training iterations, the distribution D may converge to D′, meaning that the generator has learned to generate data appearing to be drawn from a distribution D representing user-realistic path features.

In some embodiments, because of the cyclical architecture of system 800, costs are applied symmetrically between when a synthetic path is modified to appear user-realistic (FIG. 8A) and when a user-generated path is modified to appear synthetic (FIG. 8B). Thus, equation (15) applies when synthetic path X is modified based on P, and the analogous cost function K′( [symbol] ,G ), corresponding to both the generator and the discriminator, may be optimized according to:

$${min}_{G} {max}_{𝒟} {K}^{′} ( 𝒟 , G ) 0 = {E}_{G ( X ) ∼ D} \{ log [ 𝒟 ( G ( X ) ) ] \} + {E}_{G ( P ) ∼ {D}^{′}} \{ log [ 1 - 𝒟 ( G ( P ) ) ] ] , \qquad ( 16 )$$

when P is modified based on X to generate a path that appears synthetic.

Because the network of FIG. 8A may modify a synthetic path to appear user-realistic, and because the network of FIG. 8B may use the result of the modification to modify a (reconstructed) user-generated path to appear synthetic, it may be desirable for the modified user-generated path to sufficiently match the original synthetic path to ensure cycle consistency. Thus, in some embodiments, training the generative network includes optimizing an additional cycle consistency cost function K_{cyc}(G) according to:

$${min}_{G} {K}_{c y c} ( G ) = {E}_{G ( X ) ∼ {D}^{′}} \{ {‖ G ( X ) - G ( P ) ‖}_{1} \} + {E}_{G ( P ) ∼ {D}^{′}} [ {‖ G ( P ) - G ( X ) ‖}_{1} \} , \qquad ( 17 )$$

where ∥⋅∥₁ denotes the L₁ norm.

In some embodiments, training the classifier of system 800 similarly involves optimizing a respective cost function [symbol] (C), e.g., by reducing the cost function at each training iteration. For example, the classifier is trained using the same techniques discussed above for training classifier 712, e.g., by optimizing a CTC loss function.

In some embodiments, training the decoder ( [symbol] ) of system 800 similarly involves optimizing a respective cost function [symbol] ′( [symbol] ), e.g, by reducing the cost function at each training iteration. In some embodiments, the cost uncton may differ depending on whether the path that was modified is user-generated or synthetic. For example, when the path to be modified is user-generated (e.g., decoder 836 in FIG. 8B), it may be desirable to minimize the distortion to the original path incurred by the encoder, so a minimum mean square error (MMSE) cost function may be used. When the path to be modified is synthetic (e.g., decoder 818 in FIG. 8A), the CTC cost function may be used, as it may be undesirable to penalize user-realistic modifications to the synthetic path.

In some embodiments, training system 800 includes jointly training the generative network, the discriminator, the classifier, and the decoder according to the above discussed techniques. For example, the following cost function M(C, [symbol] , D, G), a linear interpretation of the above-discussed cost functions, is optimized (e.g., reduced at each training iteration):

M(C, [symbol] , [symbol] ,G)=λ₁· [symbol] · [symbol] (C)+λ₂· [symbol] ′( [symbol] )+λ₃·[K( [symbol] ,G)+K′( [symbol] ,G)+K_{cyc}(G)], (18)

where the scalar coefficients λᵢ are tunable weighting parameters adjusting the contribution from the respective classification, decoding, and generation/discrimination processes, and where λ₁+λ₂+λ₃=1. Training system 800 in this manner may thus train the generative network to generate data (e.g., embeddings) accurately representing user-realistic (or synthetic) paths, while concurrently training the classifier (e.g., a path recognition model) to accurately recognize paths and training the discriminator to accurately determine whether paths are user-realistic or synthetic.

FIG. 9 illustrates system 900 for generating and recognizing keyboard paths and for training models for keyboard path recognition, according to some embodiments. In some embodiments, system 900 is implemented on one or more electronic devices (e.g., 100, 300, 500, or 600) and the components and functions of system 900 may be distributed in any manner between the devices. In some embodiments, system 900 is implemented on one or more server devices having architectures similar to or the same as devices 100, 300, 500, or 600 (e.g., processors (CPU(s), GPU(s)), network interfaces, controllers, and memories) but with greater memory, computing, and/or processing resources than devices 100, 300, 500, or 600. System 900 is implemented using hardware, software, or a combination of hardware and software to carry out the principles discussed herein. For example, one or more components of system 900 may be implemented as computer-executable instructions stored in the memor(ies) of devices 100, 300, 500, or 600.

System 900 is exemplary, and thus system 900 can have more or fewer components than shown, can combine two or more components, or can have a different configuration or arrangement of the components. Further, although the below discussion describes functions being performed at a single component of system 900, it is to be understood that such functions can be performed at other components of system 900 and that such functions can be performed at more than one component of system 900.

System 900 includes corpus 902. Corpus 902 includes data representing paths. For example, corpus 902 includes a first corpus including data representing a plurality of user-generated paths (or reconstructions thereof) and a second corpus including data representing a plurality of synthetic paths (or reconstructions thereof).

System 900 includes generating unit 904. In some embodiments, generating unit 904 includes generative network 708. In some embodiments, generating unit 904 includes first and second instances of a generative network, e.g., 806 and 824, respectively.

In some embodiments, generating unit 904 includes encoding unit 906. In some embodiments, encoding unit 906 includes first and second instances of an encoder, e.g., 810 and 826, respectively.

In some embodiments, generating unit 904 includes attention unit 908. In some embodiments, attention unit 908 includes first and second instances of an attention model, e.g., 808 and 828, respectively.

System 900 includes discriminating unit 910. In some embodiments discriminating unit 910 includes discriminator 710. In some embodiments, discriminating unit 910 includes first and second instances of a discriminator, e.g., 814 and 834, respectively.

System 900 includes path recognition unit 912. In some embodiments, path recognition unit 912 includes a path recognition model configured to accept data representing a path and determine a word corresponding to the path. For example, path recognition unit 912 includes classifier 712. In some embodiments, path recognition unit 912 includes first and second instances of a classifier, e.g., 816 and 832, respectively.

System 900 includes decoding unit 914. In some embodiments, decoding unit 914 includes first and second instances of a decoder, e.g., 818 and 836, respectively.

System 900 includes training unit 916. Training unit 916 is configured to train the components of system 900 according to the techniques discussed herein. For example, training unit 916 is configured to optimize respective cost functions corresponding to the various components of system 900.

FIGS. 10A-C illustrate a flow diagram of process 1000 for generating and recognizing keyboard paths, according to some embodiments. In some embodiments, process 1000 is performed at one or more electronic devices (e.g., 100, 300, 500, 600) each having one or more processors and memory. In some embodiments, process 1000 is performed using a client-server system, with the operations of process 1000 divided up in any manner between the client device(s) (e.g., 100, 300, 500, 600) and the server. Some operations in process 1000 are, optionally, combined, the orders of some operations are, optionally, changed, and some operations are, optionally, omitted.

At block 1002, first data representing a user-generated keyboard path for one or more words is obtained (e.g., by generating unit 904). In some embodiments, the first data indicate one or more of: spatial coordinates for the user-generated keyboard path; and characters corresponding to the user-generated keyboard path.

At block 1004, second data representing a synthetic keyboard path for the one or more words is obtained (e.g., by generating unit 904). In some embodiments, the second data indicate one or more of: spatial coordinates for the synthetic keyboard path; and characters corresponding to the synthetic keyboard path.

At block 1006, third data representing a modification of the synthetic keyboard path (e.g., 706 or 812) are generated using a first instance of a generative network (e.g., 708 or 806) based on the first data and the second data (e.g., by generating unit 904). In some embodiments, the first instance of the generative network includes a first instance of an encoder (e.g., 810) and a first instance of an attention model (e.g., 808), where the first instance of the attention model is configured to determine information representing an alignment between a portion of the modification of the synthetic keyboard path and a corresponding character. In some embodiments, the third data include an embedding generated using the first instance of the encoder and the first instance of the attention model, the embedding including the information representing the alignment. In some embodiments, the generative network is trained to generate data representing modifications of keyboard paths, where the data representing modifications of keyboard paths have a first probability distribution corresponding to a second probability distribution of data representing a second plurality of user-generated keyboard paths included in a second corpus.

At block 1008, it is determined whether the third data represent a second user-generated keyboard path (e.g., by discriminating unit 910). In some embodiments, determining whether the third data represent a second user-generated keyboard path is performed using a first instance of a discriminator (e.g., 710 or 814). In some embodiments, determining whether the third data represent a second user-generated keyboard path includes determining, based on a corpus including data representing a plurality of user-generated keyboard paths, a probability that the modification of the synthetic keyboard path is user-realistic, as shown in block 1010.

At block 1012, it is determined whether the third data represent the one or more words (e.g., by path recognition unit 912). In some embodiments, determining whether the third data represent the one or more words is performed using a first instance of a classifier (e.g., 712 or 816) configured to recognize keyboard path inputs. In some embodiments, determining whether the third data represent the one or more words includes: determining respective probabilities that the third data represent each word of a vocabulary, the vocabulary including the one or more words (block 1014) and determining that the probability that the third data represent the one or more words is the highest probability of the respective probabilities (block 1016).

At block 1018, in some embodiments, in accordance with a determination that the third data does not represent a second user-generated keyboard path, a first set of one or more parameters of the generative network are adjusted (e.g., by generating unit 904).

At block 1020, in some embodiments, in accordance with a determination that the third data does not represent the one or more words, a second set of one or more parameters of the generative network are adjusted (e.g., by generating unit 904).

At block 1022, in some embodiments, a reconstruction of the first data (e.g., 820) and a reconstruction of the second data are determined using a first instance of a decoder (e.g., 818) and based on the third data (e.g., by decoding unit 914).

At block 1024, in some embodiments, fourth data representing a second synthetic keyboard path for the one or more words are obtained (e.g., 822) (e.g., by generating unit 904).

At block 1026, in some embodiments, fifth data representing a modification of the user-generated keyboard path (e.g., 830) are generated using a second instance of the generative network (e.g., 824), based on the reconstruction of the first data and the fourth data, (e.g., by generating unit 904). In some embodiments, the second instance of the generative network includes a second instance of the encoder (e.g., 826) and a second instance of the attention model (e.g., 828).

At block 1028, in some embodiments, it is determined, using a second instance of the classifier (e.g., 832), whether the fifth data represent the one or more words (e.g., by path recognition unit 912).

At block 1030, in some embodiments, it is determined, using a second instance of the discriminator (e.g., 834), whether the fifth data represent a synthetic keyboard path (e.g., by discriminating unit 910).

At block 1032, in some embodiments, a reconstruction of the fourth data representing the second synthetic keyboard path for the one or more words (e.g., 838) is determined using a second instance of the decoder (e.g., 836) based on the fifth data (e.g., by decoding unit 914).

At block 1034, in some embodiments, in accordance with a determination that the fifth data represent the one or more words and a determination that the fifth data represent a synthetic keyboard path: the reconstruction of the fourth data is provided to the first instance of the generative network to generate additional data representing a modification of the second synthetic keyboard path (e.g., by decoding unit 914).

At block 1036, in some embodiments, the generative network, the decoder, the classifier, and the discriminator are trained based on the reconstruction of the first data and the reconstruction of the fourth data (e.g., by training unit 916). In some embodiments, training the generative network, the decoder, the classifier, and the discriminator includes optimizing respective cost functions including a cycle consistency cost function (e.g., equation 17).

At block 1038, in accordance with a determination that the third data represent a second user-generated keyboard path and a determination that the third data represent the one or more words, a model for keyboard path recognition is trained based on the third data (e.g., by training unit 916). In some embodiments, training the model for keyboard path recognition includes training the classifier (e.g., 816 and/or 832) based on the reconstruction of the first data and the reconstruction of the fourth data, as shown in block 1040.

The operations described above with reference to FIGS. 10A-C are optionally implemented by components depicted in FIGS. 6A-C, 7, 8A-C, and 9. For example, the operations of process 1000 may be implemented by system 900. It would be clear to a person having ordinary skill in the art how other processes are implemented based on the components depicted in FIGS. 6A-C, 7, 8A-C, and 9.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A non-transitory computer-readable storage medium storing one or more programs, the one or more programs comprising instructions, which when executed by one or more processors of a first electronic device, cause the first electronic device to:
obtain first data representing a user-generated keyboard path for one or more words;
obtain second data representing a synthetic keyboard path for the one or more words;
generate, using a first instance of a generative network, based on the first data and the second data, third data representing a modification of the synthetic keyboard path;
determine whether the third data represent a second user-generated keyboard path;
determine whether the third data represent the one or more words; and
in accordance with a determination that the third data represent a second user-generated keyboard path and a determination that the third data represent the one or more words:
train a model for keyboard path recognition based on the third data.

2. The non-transitory computer-readable storage medium of claim 1, wherein the first data indicate one or more of:
spatial coordinates for the user-generated keyboard path; and
characters corresponding to the user-generated keyboard path.

3. The non-transitory computer-readable storage medium of claim 1, wherein the second data indicate one or more of:
spatial coordinates for the synthetic keyboard path; and
characters corresponding to the synthetic keyboard path.

4. The non-transitory computer-readable storage medium of claim 1, wherein:
determining whether the third data represent a second user-generated keyboard path is performed using a first instance of a discriminator; and
determining whether the third data represent the one or more words is performed using a first instance of a classifier configured to recognize keyboard path inputs.

5. The non-transitory computer-readable storage medium of claim 4, wherein the first instance of the generative network includes:
a first instance of an encoder; and
a first instance of an attention model, wherein the first instance of the attention model is configured to determine information representing an alignment between a portion of the modification of the synthetic keyboard path and a corresponding character.

6. The non-transitory computer-readable storage medium of claim 5, wherein the third data include an embedding generated using the first instance of the encoder and the first instance of the attention model, the embedding including the information representing the alignment.

7. The non-transitory computer-readable storage medium of claim 5, wherein the one or more programs further comprise instructions, which when executed by the one or more processors, cause the electronic device to:
determine, using a first instance of a decoder and based on the third data:
a reconstruction of the first data; and
a reconstruction of the second data.

8. The non-transitory computer-readable storage medium of claim 7, wherein the one or more programs further comprise instructions, which when executed by the one or more processors, cause the electronic device to:
obtain fourth data representing a second synthetic keyboard path for the one or more words;
generate, using a second instance of the generative network, based on the reconstruction of the first data and the fourth data, fifth data representing a modification of the user-generated keyboard path, wherein:
the second instance of the generative network includes a second instance of the encoder and a second instance of the attention model.

9. The non-transitory computer-readable storage medium of claim 8, wherein the one or more programs further comprise instructions, which when executed by the one or more processors, cause the electronic device to:
determine, using a second instance of the classifier, whether the fifth data represent the one or more words;
determine, using a second instance of the discriminator, whether the fifth data represent a synthetic keyboard path; and
determine, using a second instance of the decoder, based on the fifth data, a reconstruction of the fourth data representing the second synthetic keyboard path for the one or more words.

10. The non-transitory computer-readable storage medium of claim 9, wherein the one or more programs further comprise instructions, which when executed by the one or more processors, cause the electronic device to:
in accordance with a determination that the fifth data represent the one or more words and a determination that the fifth data represent a synthetic keyboard path:
provide the reconstruction of the fourth data to the first instance of the generative network to generate additional data representing a modification of the second synthetic keyboard path.

11. The non-transitory computer-readable storage medium of claim 9, wherein the one or more programs further comprise instructions, which when executed by the one or more processors, cause the electronic device to:
train the generative network, the decoder, the classifier, and the discriminator based on the reconstruction of the first data and the reconstruction of the fourth data, wherein training the generative network, the decoder, the classifier, and the discriminator includes optimizing respective cost functions including a cycle consistency cost function.

12. The non-transitory computer-readable storage medium of claim 9, wherein training the model for keyboard path recognition includes training the classifier based on the reconstruction of the first data and the reconstruction of the fourth data.

13. The non-transitory computer-readable storage medium of claim 1, wherein the one or more programs further comprise instructions, which when executed by the one or more processors, cause the electronic device to:
in accordance with a determination that the third data does not represent a second user-generated keyboard path, adjust a first set of one or more parameters of the generative network; and
in accordance with a determination that the third data does not represent the one or more words, adjust a second set of one or more parameters of the generative network.

14. The non-transitory computer-readable storage medium of claim 1, wherein determining whether the third data represent a second user-generated keyboard path includes:
determining, based on a corpus including data representing a plurality of user-generated keyboard paths, a probability that the modification of the synthetic keyboard path is user-realistic.

15. The non-transitory computer-readable storage medium of claim 1, wherein determining whether the third data represent the one or more words includes:
determining respective probabilities that the third data represent each word of a vocabulary, the vocabulary including the one or more words; and
determining that the probability that the third data represent the one or more words is the highest probability of the respective probabilities.

16. The non-transitory computer-readable storage medium of claim 1, wherein the generative network is trained to generate data representing modifications of keyboard paths, wherein the data representing modifications of keyboard paths have a first probability distribution corresponding to a second probability distribution of data representing a second plurality of user-generated keyboard paths included in a second corpus.

17. An electronic device, comprising:
one or more processors;
a memory; and
one or more programs, wherein the one or more programs are stored in the memory and configured to be executed by the one or more processors, the one or more programs including instructions for:
obtaining first data representing a user-generated keyboard path for one or more words;
obtaining second data representing a synthetic keyboard path for the one or more words;
generating, using a first instance of a generative network, based on the first data and the second data, third data representing a modification of the synthetic keyboard path;
determining whether the third data represent a second user-generated keyboard path;
determining whether the third data represent the one or more words; and
in accordance with a determination that the third data represent a second user-generated keyboard path and a determination that the third data represent the one or more words:
training a model for keyboard path recognition based on the third data.

18. A method for generating and recognizing keyboard paths, the method comprising:
at an electronic device with one or more processors and memory:
obtaining first data representing a user-generated keyboard path for one or more words;
obtaining second data representing a synthetic keyboard path for the one or more words;
generating, using a first instance of a generative network, based on the first data and the second data, third data representing a modification of the synthetic keyboard path;
determining whether the third data represent a second user-generated keyboard path;
determining whether the third data represent the one or more words; and
in accordance with a determination that the third data represent a second user-generated keyboard path and a determination that the third data represent the one or more words:
training a model for keyboard path recognition based on the third data.
